(19) United States
(12) Patent Application Publication
(10) Pub. No.: US 2012/0174003 A1
(43) Pub. Date: Jul. 5, 2012

(54) APPLICATION MANAGMENT SYSTEM AND METHOD USING THE SAME

(75) Inventor: MING LI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/304,293

(22) Filed: Nov. 23, 2011

(30) Foreign Application Priority Data
Dec. 31, 2010 (CN) 201010616923.1

(51) Int. Cl. G06F 3/048; G06F 9/44

(52) U.S. Cl. 715/763; 719/320

(57) ABSTRACT

An application management system and method controls one or more applications according to commands generated by one or more assigned peripherals. The application management system assigns a first peripheral to a first application and assigns a second peripheral to a second application. The application management system stores the commands generated by the first peripheral into a first buffering region and storing the commands generated by the second peripheral into a second buffering region. The application management system distributes for execution the stored commands according to the assignments of applications to peripherals.

### 1. TECHNICAL FIELD

The disclosure generally relates to application management systems and, particularly, to a multi-peripheral based application management system and a method using the same.

### 2. DESCRIPTION OF RELATED ART

An electronic device can connect with more than one peripheral, e.g., a mouse, a keyboard, and/or a remote control joystick, and also can simultaneously run many different applications. However, generally speaking, only one of the applications can be controlled by one of the peripherals on the same electronic device at a same time. Accordingly, it is an inconvenience if the user wants to control more than one application via different peripherals on the same electronic device at a same time.

Therefore, it is desirable to provide a multi-peripheral based application management system and a method using same, which can overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a system view of one embodiment of an application management system.

FIG. 2 is a block diagram of one embodiment of the electronic device included in FIG. 1.

FIG. 3 is a schematic view showing one embodiment of the building of a relationship between an application and a specified peripheral.

FIG. 4 is a schematic view showing one embodiment of two peripherals controlling two applications at the same time.

FIG. 5 shows a flowchart of one embodiment of an application managing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY disc, flash memories, and hard disk drives.

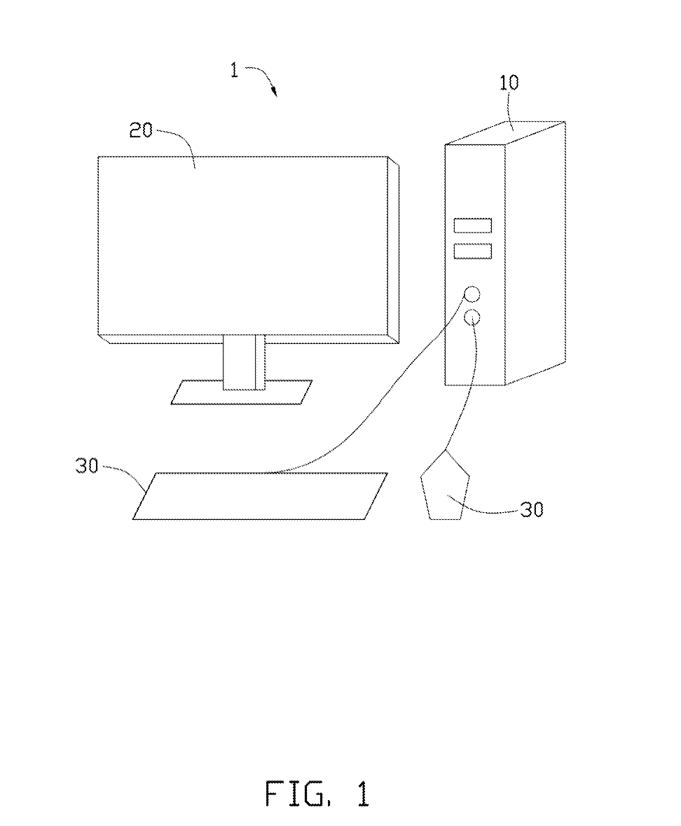

FIG. 1 is a system view of one embodiment of an application management system 1. In one embodiment, the application management system 1 includes a display 20, an electronic device 10, and a number of peripherals 30. Each of the peripherals 30 connects with the electronic device 10 and may control a number of applications which can be run by the electronic device 10. The application may be a computer game, a office software, or any other computerized instructions combination capable of carrying out some functions.

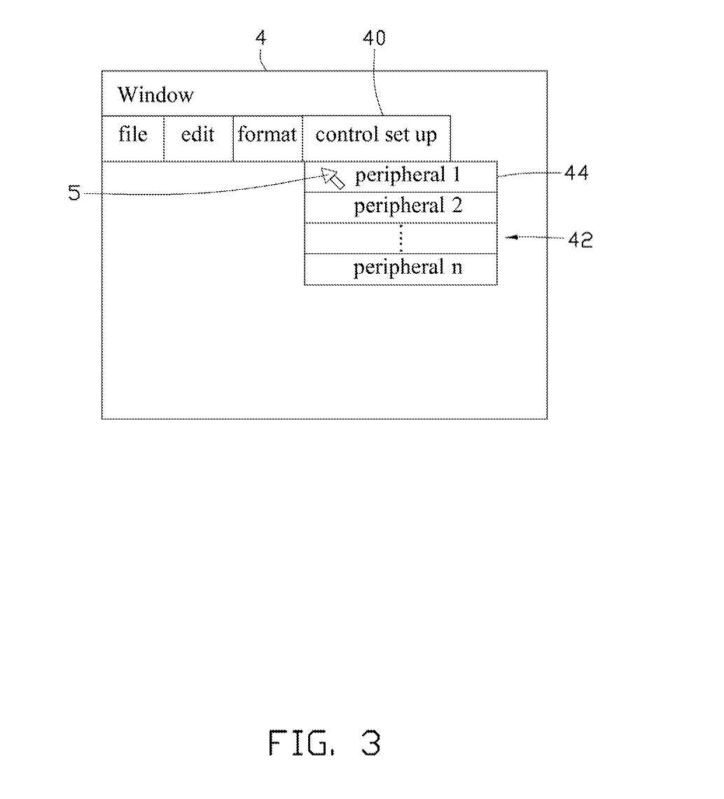

The display 20, such as a liquid crystal display (LCD) or an organic light emitting display (OLED), displays a graphical user interface representing the application. For example, referring to FIG. 3, a window 4 is displayed on the display 20 when an application starts running. The window 4 includes a number of graphical buttons 40 and menu options 44 corresponding to a number of different functions within the application. A user can control the application by clicking the buttons 40 or the menu options 44 via any of the peripherals 30 listed.

The peripherals 30 are configured for generating commands according to the actions of the user. The commands are transmitted to the electronic device 10. In this embodiment, the peripherals 30 can include at least one mouse, a keyboard, a remote controller, and a microphone.

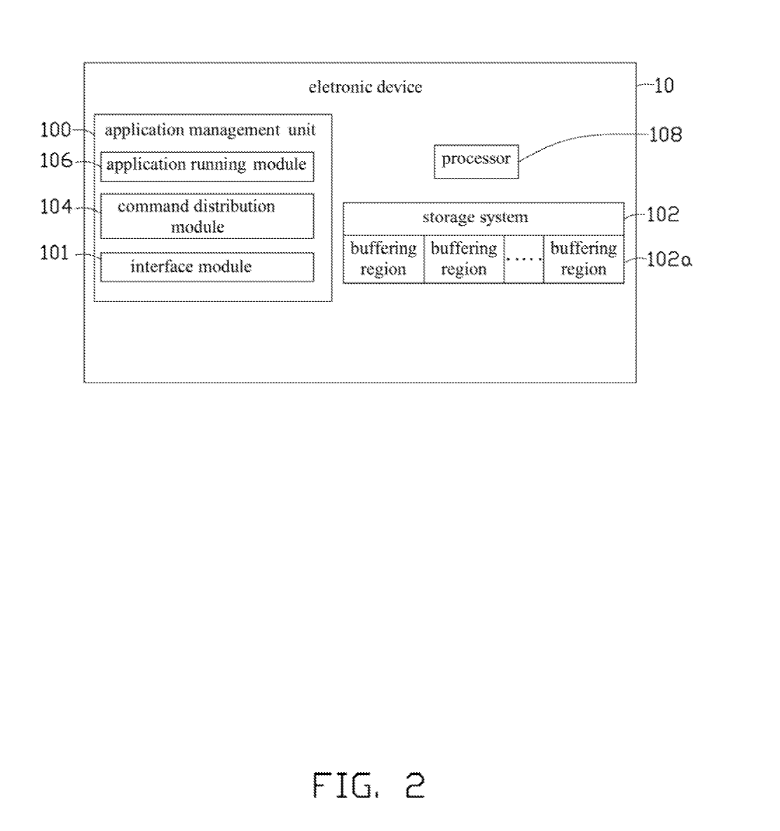

FIG. 2 is a block diagram of one embodiment of the electronic device 10. The electronic device 10 may be a computer, a game console, or a mobile phone, or any other program-processing device. In one embodiment, the electronic device 10 includes a storage system 102, at least one processor 108, and an application management unit 100. The application management unit 100 includes an interface module 101, a command distribution module 104, and an application running module 106. The modules 101, 104, and 106 may include computerized code in the form of one or more programs that are stored in the storage system 102. The computerized code includes computer-readable programs (instructions) that are executed by the at least one processor 108 to provide functions for the modules 101, 104, and 106. The storage system 102 may be a cache or a dedicated memory, such as an EPROM, HDD, or flash memory.

The storage system 102 includes a number of buffering regions 102a. Each buffering region 102a is assigned to one of the connected peripherals 30. Each of the buffering regions 102a is configured for storing the commands generated by the peripherals 30.

The interface module 101 arranges for the storage of the commands generated by the peripherals 30 in the corresponding buffering regions 102a.

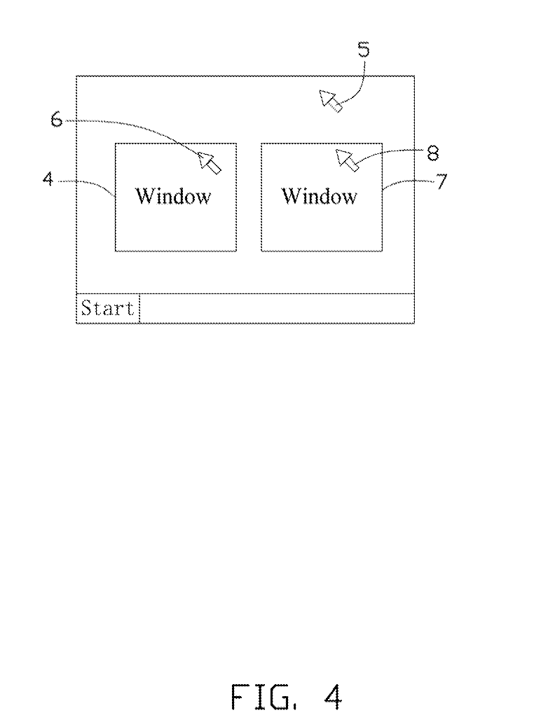

The command distribution module 104 assigns one of the at least two peripherals 30 to one of the at least two applications and appropriately distributes the commands of each of the peripherals 30 to control the corresponding application. The application can be a specific application whether open or not. In detail, the command distribution unit 104 assigns one of the peripherals 30 to an application by building a relationship between the buffering region 102a corresponding to the assigned peripheral 30 and the application which is made to correspond to a particular peripheral 30 according to the selection of the user. In one embodiment, (referring to FIGS. 3 and 4) when a first application starts running, a first window 4 is shown on the display 20. At the beginning, one of peripherals 30 is defined as a basic peripheral 30 and may be indicated as a first cursor 5 on the display 20. The first application can be controlled by the basic peripheral 30. The first window 4 includes a “control set up” button 40. When the user clicks the “control set up” button 40 via the basic peripheral 30 (i.e., indicated by the first cursor 5 on the display 20), a dropdown list 42 shows a number of graphical options 44 indicating some available peripherals 30 connected to the electronic device 10, such as peripheral 1, peripheral 2 . . . peripheral n. If the user clicks to choose one of the available peripherals 30, the command distribution module 104 assigns the clicked or chosen peripheral 30 to the first application by building a relationship between the first application and the buffering region 102a which corresponds to the chosen peripheral 30. A second cursor 6 representing the chosen peripheral 30 is displayed when the chosen peripheral 30 has been assigned to the first application. Thereafter, the command distribution module 104 distributes all the commands stored in the buffering region 102a relating to the chosen peripheral 30 to the application running module 106 for controlling the first application. The chosen peripheral 30 (i.e., the second cursor 6 on the display 20) is only used to control the first application (i.e., the window 4 on the display 20) if the chosen peripheral 30 has been assigned to the first application. In one alternative embodiment, after the chosen peripheral 30 is assigned to the first application, the basic peripheral 30 can be inhibitive to control the first application.

In another embodiment, it is understood that another available peripheral 30 (i.e., a third cursor 8 on the display 20) can be further assigned to only control a second application (i.e., a window 7 on the display 20) by the same way mentioned above after the chosen peripheral 30 has been assigned to the first application. By these means, in this embodiment, two peripherals 30 can each control a different application on the same electronic device 10 at the same time.

The application running module 106 controls the operation of the applications according to commands transmitted from the buffering region 102a which corresponds to an assigned peripheral 30.

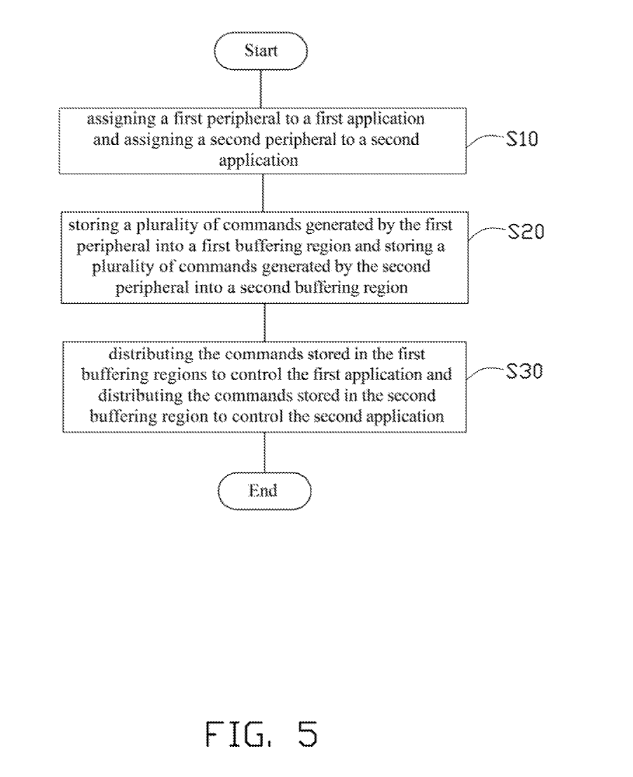

FIG. 5 is a flowchart of one embodiment of an application managing method. Depending on the embodiment, additional blocks may be added, other deleted, and the ordering of the blocks may be changed.

In block S10: the command distribution module 104 assigns a first peripheral 30 to the first application and assigns a second peripheral 30 to a second application. The command distribution module 104 assigns a peripheral 30 to an application by building a relationship between a buffering region 102a of each assigned peripheral 30 and the corresponding application.

In block S20: the interface module 101 stores commands generated by the first peripheral 30 into a first buffering region 102a and stores commands generated by a second peripheral 30 into a second buffering region 102a.

In block S30: the command distribution module 104 distributes the commands stored in the first buffering region 102a to control the operation of the first application via the application running module 106 and distributes the commands stored in the second buffering region 102a to control the operation of the second application via the application running module 106.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device in connection with a first peripheral and a second peripheral, the electronic device comprising:
a storage system comprising a first buffering region assigned to the first peripheral and a second buffering region assigned to the second peripheral;
at least one processor; and
one or more programs stored in the storage system and being executed by the at least one processor, the one or more programs comprising:
an interface module operable to store commands generated by the first peripheral into the first buffering region and store commands generated by the second peripheral into the second buffering region;
an application running module operable to control one or more applications; and
a command distribution module operable to assign the first peripheral to a first application, assign the second peripheral to a second application, distribute the commands stored in the first buffering region to control the first application via the application running module, and distribute commands stored in the second buffering region to control the second application via the application running module.

2. The electronic device of claim 1, wherein the command distribution module assigns the first peripheral to the first application by building a corresponding relationship between the first application and the first buffering region of the first peripheral.

3. The electronic device of claim 1, wherein the electronic device is connected to a display for displaying graphical interfaces of the first and second applications.

4. The electronic device of claim 3, wherein the first and second applications are correspondingly represented as a first graphical window and a second graphical window on the display, the first and second peripherals are correspondingly represented as a first graphical option and a second graphic option in the first graphical window and the second graphical window.

5. The electronic device of claim 4, wherein the command distribution module assigns the first peripheral to the first application if the first graphical option in the first window is clicked.

6. The electronic device of claim 4, wherein the command distribution module assigns the second peripheral to the second application if the second graphical option in the second window is clicked.

7. The electronic device of claim 1, wherein the electronic device is selected from the group consisting of a computer, a game console, and a mobile phone.

8. The electronic device of claim 1, wherein the first and second peripherals are selected from the group consisting of a mouse, a keyboard, a remote controller, and a microphone.

9. The electronic device of claim 3, wherein the display is selected from the group consisting of a liquid crystal display and an organic light emitting display.

10. An application managing method being performed by execution of computer readable program code by a processor of an electronic device, the method comprising:
assigning a first peripheral to a first application and assigning a second peripheral to a second application;
storing a plurality of commands generated by the first peripheral into a first buffering region assigned to the first peripheral and storing a plurality of commands generated by the second peripheral into a second buffering region assigned to the second peripheral;
distributing the commands stored in the first buffering regions to control the first application and distributing the commands stored in the second buffering region to control the second application.

11. The method of claim 10, wherein the first and second applications are correspondingly displayed as a first graphical window and a second graphical window, the first and second peripherals are correspondingly displayed as a first graphical option and a second graphical option in the first graphical window and a second graphical window.

12. The method of claim 11, wherein the first peripheral is assigned to the first application if the first graphical option in the first window is clicked.

13. The method of claim 11, wherein the second peripheral is assigned to the second application if the second graphical option in the second window is clicked.

14. The method of claim 10, wherein the first peripheral is assigned to the first application by building a corresponding relationship between the first application and the first buffering region of the first peripheral.

15. The method of claim 10, wherein the first and second peripherals are selected from a group consisting of a mouse, a keyboard, a remote controller, and a microphone.

16. An electronic device capable of connecting with a peripheral, the electronic device comprising:
a storage system comprising a buffering region assigned to the peripheral;
at least one processor; and
one or more programs stored in the storage system and being executed by the at least one processor, the one or more programs comprising:
an interface module operable to store a plurality of commands generated by the peripheral into the buffering region;
an application running module operable to control a first application and a second application; and
a command distribution module operable to assign the peripheral to the first application and distribute the commands stored in the buffering region to control the first application via the application running module, the second application can not be controlled by the commands generated by the peripheral.

17. The electronic device of claim 16, wherein the command distribution module assigns the peripheral to the first application by building a corresponding relationship between the first application and the buffering region corresponding to the first peripheral.

18. The electronic device of claim 16, wherein electronic device is connected a display for displaying graphical interfaces of the first application and the peripheral.

19. The electronic device of claim 18, wherein the first applications is correspondingly represented as a first graphical window on the display, the peripheral is correspondingly represented as a graphical option in the first window.

20. The electronic device of claim 19, wherein the command distribution module assigns the peripheral to the first application if the graphical option in the first window is clicked.
